(19) United States
(12) Patent Application Publication
(10) Pub. No.: US 2020/0314349 A1
(43) Pub. Date: Oct. 1, 2020

(54) IMAGE PROCESSING DEVICE, IMAGE PROCESSING METHOD, AND PROGRAM

(71) Applicant: CANON KABUSHIKI KAISHA, Tokyo (JP)

(72) Inventor: Ryo Oikawa, Tokyo (JP)

(21) Appl. No.: 16/821,817

(22) Filed: Mar. 17, 2020

(30) Foreign Application Priority Data
Mar. 28, 2019 (JP) 2019-063724

(51) Int. Cl. H04N 5/232; H04N 5/235; G06T 7/11; G06T 5/50

(52) U.S. Cl. CPC H04N 5/232939; H04N 5/2351; G06T 2207/20221; G06T 5/50; G06T 2207/20132; G06T 7/11

(57) ABSTRACT

An image processing device includes an acquisition unit, a designation unit, a generation unit, and a notification unit. The acquisition unit is configured to acquire a luminance value from an image. The designation unit is configured to designate a partial area of the image. The generation unit is configured to generate image information displayed on a display device. The notification unit is configured to notify the display device that displays the image information of information relating to the luminance value. Moreover, the acquisition unit acquires the luminance value from the partial area, and the notification unit notifies the display device of information relating to the luminance value acquired from the partial area. The image processing device may include a memory(ies) that stores a program of instructions, and a processor(s) configured to execute the program to cause the image processing device to implement the aforementioned unit.

### BACKGROUND

### Field

The present disclosure relates to an image processing technique for processing a display image.

### Description of the Related Art

A digital camera or a digital video camera can display an image during shooting on a display panel or an electronic viewfinder (EVF) built in the camera or on a display (display device) outside the camera. As a result, a photographer can take a picture while verifying a photographing target. Here, one item that the photographer wants to verify during shooting is a luminance level. In recent years, shooting and display in high dynamic range (HDR) has become full-scale, and HDR-related standardization and commercialization have been promoted. For example, in standards such as HDR10+, additional information such as maximum content light level (MaxCLL) and maximum frame average light level (MaxFALL) is defined. The MaxCLL is information indicating a maximum luminance value for each frame or scene, and the MaxFALL is information indicating an average luminance value for each frame. These MaxCLL and MaxFALL information can be transmitted between devices according to high-definition multimedia interface (HDMI® which is a registered trademark) standard. As a result, luminance information of a video is dynamically transmitted from a camera to a display, and display luminance of the display can be easily adjusted. On the other hand, there is an image called a letter box or a pillar box in which the image is partially black in a frame. In such an image, the MaxFALL information may be contrary to photographer's intention.

Note that in Japanese Patent Laid-Open No. 2007-140483, in order to match a display video with photographer's intention, a characteristic amount of a video is measured as a display device, and luminance of a backlight light source is controlled according to the characteristic amount. Thus, a display device that realizes video display with optimum display quality is disclosed.

By the way, there is a camera that displays an entire image read from an imaging sensor during shooting standby and that can crop and record a partial image area when shooting is performed, for example. This camera is devised to display a frame indicating a crop area on the entire image read from the imaging sensor so that the crop area shot in the shooting standby state can be understood.

### SUMMARY

In accordance with an aspect of the present disclosure, an image processing device includes an acquisition unit, a designation unit, a generation unit, and a notification unit. The acquisition unit is configured to acquire a luminance value from an image. The designation unit is configured to designate a partial area of the image. The generation unit is configured to generate image information displayed on a display device. The notification unit is configured to notify the display device that displays the image information of information relating to the luminance value. Moreover, the acquisition unit acquires the luminance value from the partial area, and the notification unit notifies the display device of information relating to the luminance value acquired from the partial area. The image processing device may include, for example, a memory or memories that store a program of instructions, and a processor or processors configured to execute the program to cause the image processing device to implement the aforementioned unit.

Further features of the present disclosure will become apparent from the following description of exemplary embodiments (with reference to the attached drawings).

### BRIEF DESCRIPTION OF THE DRAWINGS

FIG. 1A is a block diagram illustrating a configuration example of an imaging apparatus according to a first embodiment.

FIG. 1B is a block diagram illustrating a configuration example of an imaging apparatus according to a second embodiment.

FIG. 2A is a view showing an example of a display image when an imageable aspect and a displayable aspect are different.

FIG. 2B is a view showing an example of a display image when a face frame area is cropped and displayed.

FIG. 3A is a graph showing a relationship between MaxFALL and time.

FIG. 3B is a graph showing a relationship between MaxCLL/MaxFALL and time.

FIG. 4 is a flowchart showing a flow of processing according to the first and second embodiments.

FIG. 5A is a block diagram illustrating a configuration example of an imaging apparatus according to a third embodiment.

FIG. 5B is a block diagram showing another configuration example of the imaging apparatus according to the third embodiment.

FIG. 6 is a flowchart showing a flow of processing according to the third embodiment.

### DESCRIPTION OF THE EMBODIMENTS

Hereinafter, various embodiments of the present disclosure will be described in detail with reference to the accompanying drawings.

As described above, when an entire image is displayed during shooting standby and an image cropped and recorded during shooting is displayed on a display device, display suitable for photographer's intention may not be performed. For example, in a conventional display device that does not correspond to display video adjustment using MaxCLL information or MaxFALL information, display video adjustment based on such information is not possible, so it is often impossible to perform display suitable for photographer's intention. Further, even when a display device that corresponds to the display video adjustment using the MaxCLL information or the MaxFALL information, it may not be possible to perform display suitable for photographer's intention. For example, when display luminance is adjusted using the MaxFALL information, MaxFALL information outside a crop area that has been actually recorded during still image shooting is used, and an image with display luminance different from luminance recorded during shooting may be displayed on a display.

Therefore, an object of the present embodiment is to make it possible to display an image on a display device with display luminance suitable for photographer's intention.

An image processing device according to the present embodiment is a device that can generate a display image to be displayed on a display device from an image captured by an imaging apparatus, and in particular, that generates a display luminance evaluation value when an image is displayed on the display device. The image processing device of the present embodiment can be applied to an imaging apparatus such as a digital camera and an information processing apparatus such as a personal computer. Further, it is assumed that the imaging apparatus, to which the image processing device of the present embodiment is applied, is a camera that displays an entire image read from an imaging sensor during shooting standby and that can crop and record a partial image area when shooting is performed, for example. For this reason, it is assumed that the imaging apparatus according to the present embodiment has a function of displaying a frame indicating a crop area on the image read from the imaging sensor so that the crop area shot in the shooting standby state can be understood.

### First Embodiment

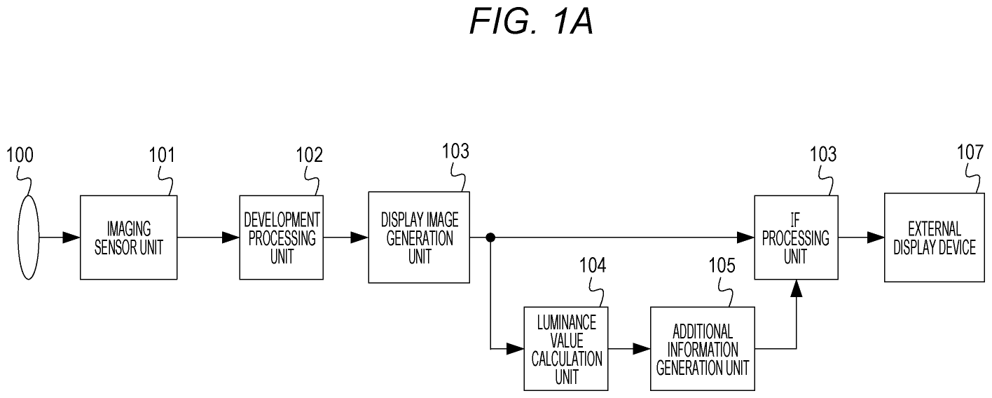

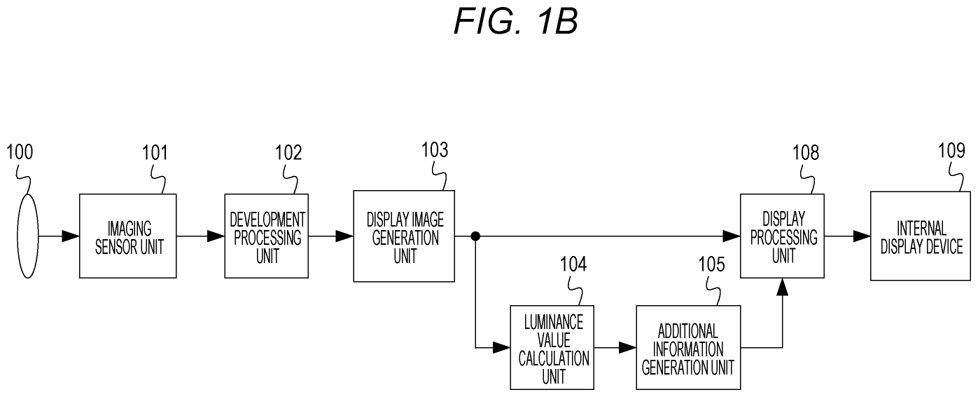

FIG. 1A is a block diagram illustrating a functional configuration of an imaging apparatus according to a first embodiment. The imaging apparatus shown in FIG. 1A has functions of extracting and calculating a luminance value from an area designated as a crop area in an entire image read from an imaging sensor unit 101, and of transmitting image data to an external display device 107 and notifying the external display device 107 of information on the luminance value. In the following description, it is assumed that MaxCLL and MaxFALL information is calculated for each frame as the information on the luminance value. The MaxCLL and the MaxFALL are additional information defined in the above-described standards such as HDR10+. The MaxCLL is information indicating a maximum luminance value for each frame or scene, and the MaxFALL is information indicating an average luminance value for each frame. Further, as described above, the MaxCLL and MaxFALL information can be transmitted between devices, and the imaging apparatus can dynamically notify the external display device 107 of video luminance information. The imaging apparatus shown in FIG. 1A can calculate MaxFALL information only in the crop area in the entire image read from the imaging sensor unit 101 and transmit it to the external display device 107.

In the imaging apparatus of FIG. 1A, the imaging sensor unit 101 is an imaging element such as a CCD or a CMOS. The imaging sensor unit 101 photoelectrically converts an image formed by adjusting a quantity of incident light and focus by a lens group 100, and further outputs analog-digital converted image data. In each pixel of the imaging element, one of R (red), G (green), and B (blue) color filters is arranged in a predetermined array. The predetermined array in the color filter is, for example, a mosaic structure in which one red pixel, one blue pixel, and two green pixels are regularly arranged every four pixels, and such a mosaic array is generally called a Bayer array. The image data output from the imaging sensor unit 101 is sent to a development processing unit 102 as Bayer image data.

The development processing unit 102 first performs RGB offset adjustment, gain adjustment, and gamma correction processing on the Bayer image. The gamma correction processing is characteristic processing for generating a recorded image desired by a user of the imaging apparatus in consideration of characteristics of the imaging sensor unit 101, the lens group 100, and the like. By changing a gamma correction value, it is possible to generate a recorded image for displaying on a TV monitor or the like, or to generate a recorded image that reproduces texture and gradation of a movie film, Next, the development processing unit 102 converts the RGB image data into luminance (Y) and color difference (Cb, Cr) data and outputs the data. The development processing unit 102 also performs correction processing for distorted aberration of the lens group 100, processing related to image stabilization processing and noise reduction processing of the imaging apparatus, and the like. Data processed by the development processing unit 102 is sent to a display image generation unit 103.

The display image generation unit 103 performs, on the image data converted into the luminance (Y) and the color difference (Cb, Cr) by the development processing unit 102, processing for converting into display resolution, processing for adjusting data amounts of the luminance and the color difference (bit widths), and the like. Further, the display image generation unit 103 generates a display image by superimposing various display information. As the display information to be superimposed, shooting assist information represented by drawings, characters, lines, and the like can be given.

Here, for example, when an aspect of a still image that can be captured by the imaging apparatus is different from an aspect of a video displayed on the external display device 107, the display image generation unit 103 can perform crop processing as necessary. For example, when the aspect of the video displayed on the external display device 107 is narrower than the aspect of the still image that can be captured by the imaging apparatus, the display image generation unit 103 performs the crop processing according to the aspect of the external display device 107 on the image captured by the imaging sensor unit 101. In addition, when an aspect of the image captured by the imaging sensor unit 101 is different from the aspect of the external display device 107, the display image generation unit 103 generates a display image obtained by superimposing an image (an image such as a line) that makes a difference in the aspects visible on the still image.

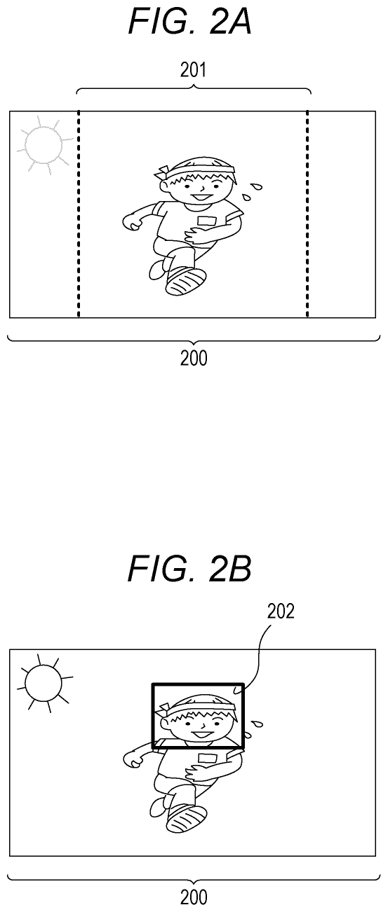

FIG. 2A is a diagram illustrating an example of an image when an aspect that can be captured by the imaging sensor unit 101 of the imaging apparatus and an aspect of a video display area that can be displayed on the external display device 107 are different. FIG. 2A shows an example in which a video display area 201 that can be displayed on the external display device 107 is narrower than an entire image area 200 captured by the imaging sensor unit 101. In a case of this example, the display image generation unit 103 generates, in the entire image area 200, an image which makes the video display area 201 that can be displayed on the external display device 107 visible, for example, a dotted line image which represents a range corresponding to an aspect of the video display area 201. Further, the display image generation unit 103 generates a display image obtained by superimposing the dotted line image on an image of the entire image area 200. Then, display image information obtained by superimposing the dotted line image representing the video display area 201 on the entire image area 200 as shown in FIG. 2A is sent to an IF processing unit 106 and a luminance value calculation unit 104.

The luminance value calculation unit 104 calculates MaxCLL indicating a maximum luminance value of the display image generated by the display image generation unit 103 and MaxFALL indicating an average luminance value for each frame. Here, when calculating the MaxFALL, the luminance value calculation unit 104 acquires, for example, a luminance value of the video display area 201 in FIG. 2A and a luminance value of an area obtained by removing the video display area 201 from the entire image area 200. Accordingly, the MaxFALL is calculated. Note that the luminance values used in the present embodiment are not limited to the maximum luminance value and the average luminance value, and may be any luminance value that can calculate information related to luminance in a designated area.

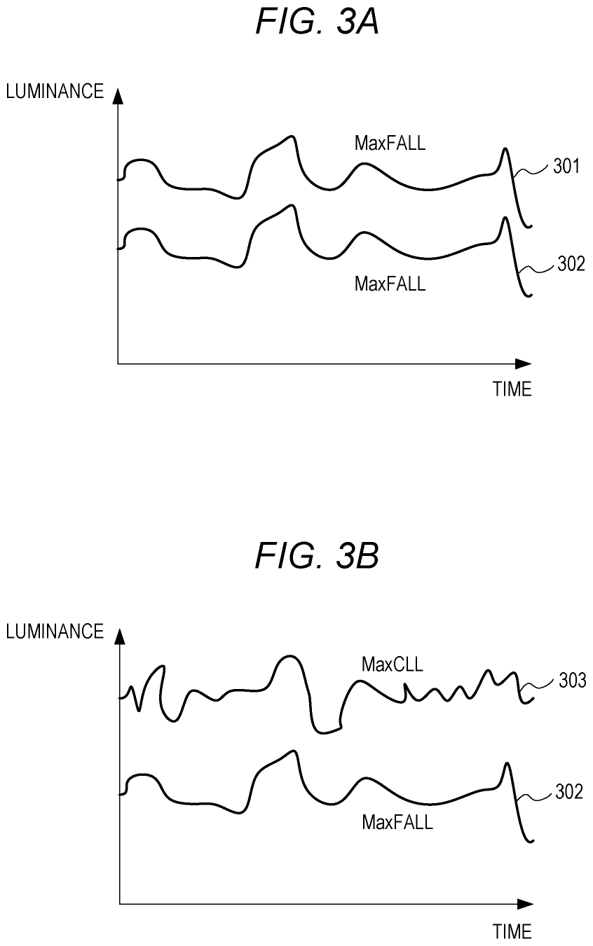

FIG. 3A is a graph showing a relationship between luminance and time of the MaxFALL calculated in the example of FIG. 2A. A curve 301 represents a relationship between luminance and time of MaxFALL calculated from the luminance value of the area obtained by removing the video display area 201 from the entire image area 200. A curve 302 represents a relationship between luminance and time of MaxFALL calculated from the video display area 201. As shown in FIG. 3A, regarding the MaxFALL, there is a difference in luminance value between the curve 301 that represents the MaxFALL calculated from the luminance value of the area obtained by removing the video display area 201 from the entire image area 200 and the curve 302 that represents the MaxFALL calculated from the video display area 201. Note that FIG. 3B is a graph illustrating a relationship between luminance values of MaxCLL and MaxFALL. As an example, a curve 303 indicates the MaxCLL, and a curve 304 indicates the MaxFALL.

Then, the luminance value calculation unit 104 sends information of the MaxCLL and the MaxFALL to an additional information generation unit 105.

The additional information generation unit 105 processes the MaxCLL and the MaxFALL generated by the luminance value calculation unit 104 to generate additional information that can be embedded in transmission data as a video transmission standard such as HDMI. Further, the additional information generation unit 105 also generates calculation area information indicating whether a value is the MaxFALL calculated from the entire image area 200 illustrated in FIG. 2A or the MaxFALL calculated from the area cropped during still image shooting as additional information. Then, the additional information generation unit 105 sends the additional information to the if processing unit 106.

Further, the additional information generation unit 105 may determine whether there is a maximum luminance value outside the video display area 201 from the MaxCLL generated by the luminance value calculation unit 104. When the maximum luminance value exists outside the area, the additional information generation unit 105 may add notification information that visibly notifies the fact to the additional information.

The IF processing unit 106 converts the display image information generated by the display image generation unit 103, the MaxCLL and MaxFALL information generated by the additional information. generation unit 105, and the calculation area information into a video signal format conforming to the video transmission standard such as HDMI, and generates transmission data. Then, the IF processing unit 106 transmits the transmission data to the external display device 107.

The external display device 107 extracts the display image information from the received transmission data, and displays an image based on the display image information. Assume that the external display device 107 is a display device having an aspect narrower than an aspect of a still image captured by the imaging apparatus. For this reason, on the external display device 107, for example, an image corresponding to the video display area 201 as shown in FIG. 2A is displayed. At this time, the external display device 107 extracts the MaxFALL information and the calculation area information from the received data, and adjusts a backlight, electric current, voltage, etc., for example, based on the extracted information to control optimum display luminance. Further, when the additional information described above includes the notification information indicating that the maximum luminance value is outside the video display area 201, the notification information is displayed on a screen of the external display device 107.

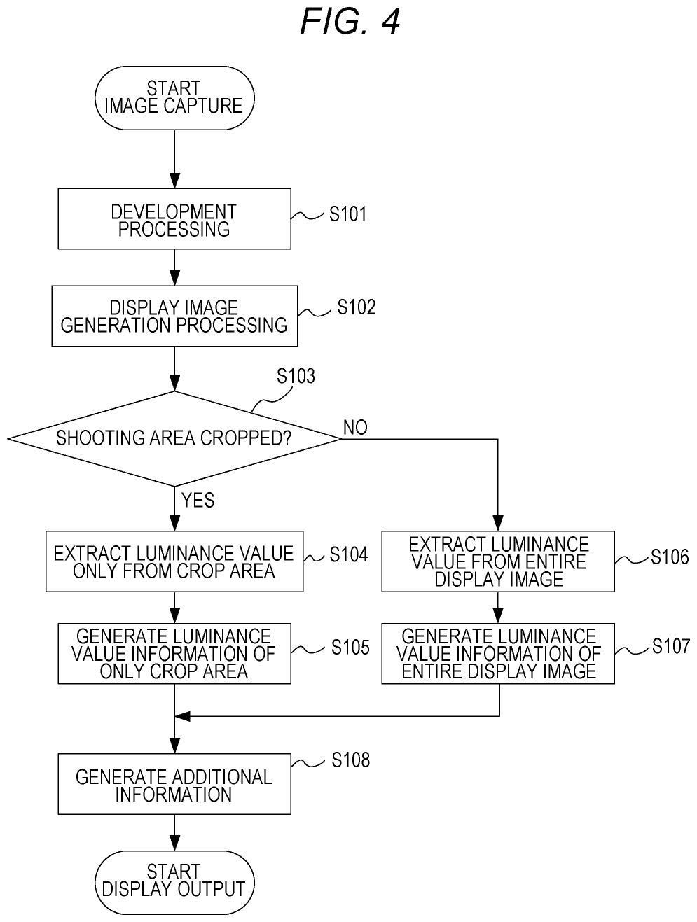

Next, a flow of processing in the imaging apparatus of the first embodiment will be described with reference to a flowchart of FIG. 4.

When image capture is started by the imaging apparatus, first, in step S101, the development processing unit 102 performs development processing on image data sent from the imaging sensor unit 101.

Next, in step S102, the display image generation unit 103 generates the above-described display image information from the developed image data. In other words, as described with reference to FIG. 2A, when crop processing is performed during still image shooting in consideration of the aspect of the display device, display image information on which lines representing an area to be cropped are superimposed is generated. In addition, characters and drawings for assisting the above-described shooting are also superimposed in step S102.

Next, in step S103, the luminance value calculation unit 104 determines whether or not the display image generation unit 103 performs crop processing. Then, the luminance value calculation unit 104 proceeds to step S104 when it is determined that the crop processing is performed, and proceeds to step S106 when it is determined that the crop processing is not performed.

In step S104, the luminance value calculation unit 104 extracts a luminance value from a crop area. For example, as shown in FIG. 2A, when the video display area 201 is cropped from the entire image area 200, the luminance value calculation unit 104 extracts the luminance value from the crop area corresponding to the video display area 201.

Next, in step S105, the additional information generation unit 105 calculates MaxCLL and MaxFALL information using the luminance value extracted only from the crop area in step S104. As described above, the MaxCLL represents a maximum luminance value for each frame, and the MaxFALL represents an average value of luminance values of all pixels in one frame.

Further, when the process proceeds to step S106, the luminance value calculation unit 104 calculates a luminance value from a display image that is not subjected to the crop processing. For example, in a case of FIG. 2A, the luminance value calculation unit 104 extracts the luminance value from the entire image area 200.

Next, in step S107, the additional information generation unit 105 calculates MaxCLL and MaxFALL information using the luminance value extracted from the display image of the entire image area. Again, as in step S105, the MaxCLL is the maximum luminance value for each frame, and the MaxFALL is the average value of the luminance values of all the pixels in one frame.

Next, in step S108, the additional information generation unit 105 generates additional information as described above using the MaxCLL and MaxFALL information calculated in step S105 or step S107.

Thereafter, the IF processing unit 106 converts the display image data and the additional information into a signal format conforming to the video transmission standard such as HDMI, and generates transmission data. The IF processing unit 106 transmits the transmission data to the external display device 107.

As described above, according to the first embodiment, the MaxFALL information suitable for photographer's intention is generated and the external display device 107 is notified thereof, so that display control at display luminance that matches the photographer's intention is possible in the external display device 107. Further, according to the present embodiment, the external display device does not need a function for measuring a characteristic amount of a video.

### Second Embodiment

Next, a second embodiment will be described. In the second embodiment, an example in which video display is performed on an internal display device included in an imaging apparatus is given. Note that the internal display device is a display device capable of HDR display.

FIG. 1B is a block diagram illustrating a functional configuration example of an imaging apparatus to which an image processing device according to the second embodiment is applied. In FIG. 1B, the same components as those in FIG. 1A of the first embodiment described above are denoted by the same reference numerals, and redundant description thereof will be omitted as appropriate. In the imaging apparatus of the second embodiment, the difference from that of the first embodiment is that a display processing unit 108 is provided instead of the IF processing unit 106 in FIG. 1A and that the display processing unit 108 is connected to an internal display device 109. Hereinafter, the display processing unit 108 and the internal display device 109 will be described.

The display processing unit 108 generates control information for optimally displaying a display image generated by a display image generation unit 103 on the internal display device 109 using MaxCLL and MaxFALL information generated by an additional information generation unit 105. Then, the display processing unit 108 transmits the control information to the internal display device 109 as transmission data together with the display image generated by the display image generation unit 103.

The internal display device 109 is a display panel or an electronic viewfinder (EVF) built in the imaging apparatus, and is connected inside the imaging apparatus according to a video transmission standard such as mobile industry processor interface (MIPI). Display luminance of the internal display device 109 is controlled by control information obtained by the display processing unit 108 converting a value of the MaxFALL into an information format that can be controlled by the MIPI.

Next, a flow of processing in the imaging apparatus of the second embodiment will be described with reference to the flowchart of FIG. 4.

Processing in steps S101 to S107 is the same as that in the first embodiment described above, and redundant description thereof will be omitted.

In a case of the second embodiment, in step S108, the additional information generation unit 105 converts the MaxCLL and MaxFALL information into information that can be embedded in transmission data as a video transmission standard such as HDMI, as in the first embodiment. The additional information generation unit 105 also generates the same calculation area information as additional information. Then, the additional information generation unit 105 sends the information to the display processing unit 108.

In step S108, the display processing unit 108 generates transmission data obtained by converting information that can be used in a general video transmission standard such as HDMI into information for the internal display device 109, and sends the transmission data to the internal display device 109. As a result, in the internal display device 109, display luminance is controlled so that the luminance is suitable for a video display area 201. Further, if the additional information includes notification information indicating that a maximum luminance value is outside the video display area 201, the internal display device 109 displays the notification information.

Also in the second embodiment, the MaxFALL information suitable for photographer's intention is generated and the internal display device 109 is notified. thereof, so that display control at display luminance that matches the photographer's intention is possible in the internal display device 109. Also in the second embodiment, the internal display device 109 does not need a function of measuring a characteristic amount of a video.

### Third Embodiment

Next, a third embodiment will be described. The third embodiment is an example in which transmission data is sent from an imaging apparatus to an external display device 107 and an internal display device 109. In the third embodiment, as shown in FIG. 2B, as an example of a specific area of a subject, a case where a face frame area 202 is displayed after being cropped will be described as an example.

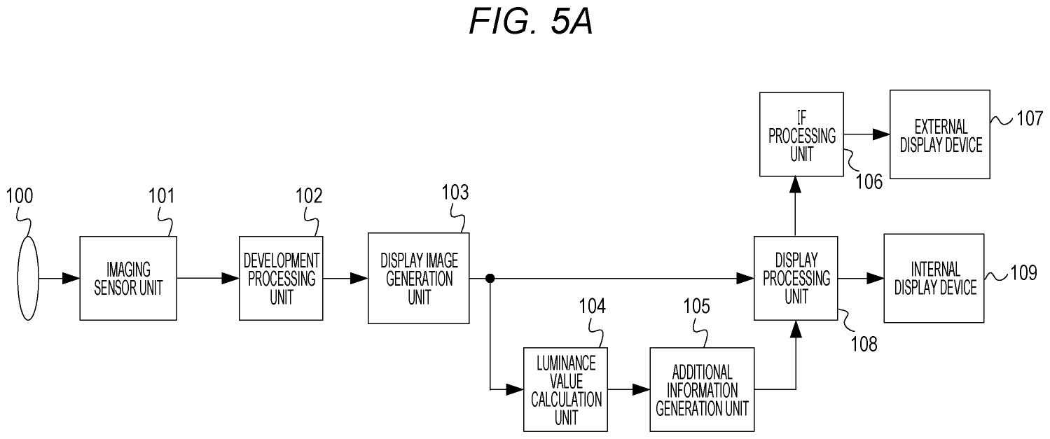

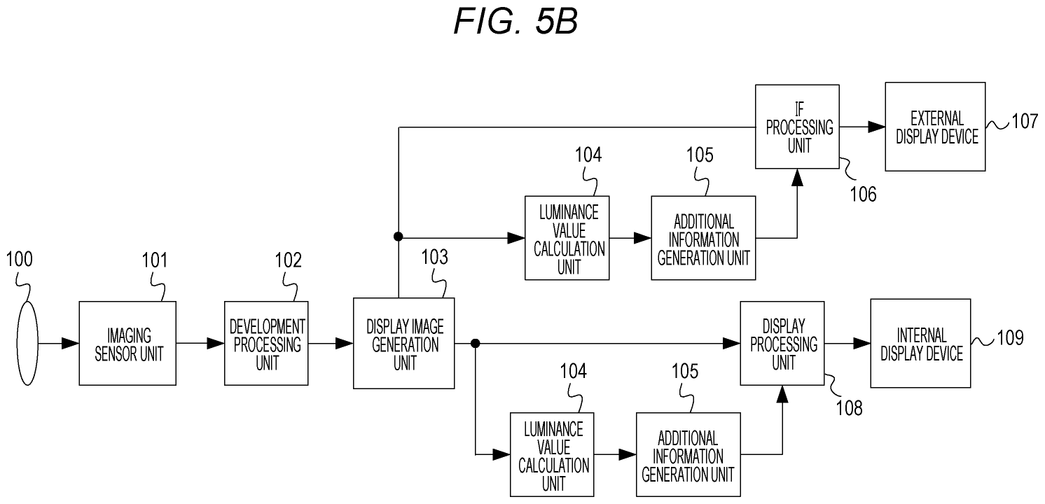

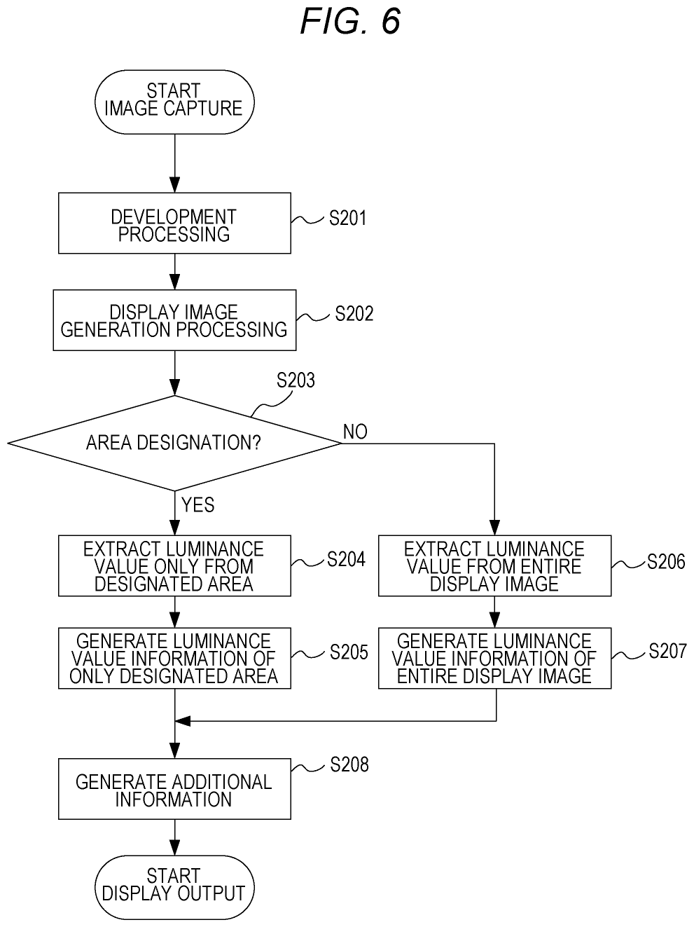

FIG. 5A is a block diagram illustrating a functional configuration example of an imaging apparatus to which an image processing device according to the third embodiment is applied. In FIG. 5A, the same components as those in FIG. 1A or FIG. 1B described above are denoted by the same reference numerals, and redundant description thereof will be omitted as appropriate. In the imaging apparatus of the third embodiment, the difference from those of the above-described embodiments is that the IF processing unit 106 and the external display device 107 described in the first embodiment and the display processing unit 108 and the internal display device 109 described in the second embodiment are provided. Further, FIG. 6 is a flowchart showing a flow of processing in the imaging apparatus of the third embodiment.

Hereinafter, the configuration and processing of the imaging apparatus according to the third embodiment will be described with reference to FIGS. 5A, 6, and 2B. Processing in steps S201 and S202 in FIG. 6 is the same as that in the corresponding steps S101 and S102 in FIG. 4. However, in the third embodiment, as shown in FIG. 2B, in order to display the face frame area 202 of the subject, a display image generation unit 103 generates a display image in which a line (for example, a solid line) corresponding to the face frame area 202 to be cropped is superimposed on an entire image area 200 in the imaging apparatus. Note that, in the same manner as in the above-described embodiments, characters, drawings, and the like that assist shooting may be superimposed on the display image. Then, display image information obtained by superimposing the solid line corresponding to the face frame area 202 on the entire image area 200 as shown in FIG. 2B is sent to the display processing unit 108 and a luminance value calculation unit 104.

After proceeding to step S203 after step S202, the luminance value calculation unit 104 determines whether or not there is crop processing area designation such as the face frame area 202 of FIG. 2B in the display image generation unit 103. Then, the luminance value calculation unit 104 proceeds to step S204 when it is determined that there is area designation, and proceeds to step S206 when it is determined that there is no area designation.

In step S204, the luminance value calculation unit 104 extracts a luminance value from the crop area subjected to the area designation.

Then, in the next step S205, the luminance value calculation unit 104 calculates MaxCLL and MaxFALL values from the extracted luminance value of only the crop area, and stores these calculated values for each frame.

Further, when the process proceeds to step S206, the luminance value calculation unit 104 extracts a luminance value from the entire image area as in step S106 of FIG. 4. Also in the next step S207, as in step S107 of FIG. 4, the luminance value calculation unit 104 calculates MaxCLL and MaxFALL values from the luminance value extracted from the entire image area, and stores them for each frame.

Next, in step S208, an additional information generation unit 105 generates additional information as described above using the MaxCLL and MaxFALL, information calculated in step S205 or step S207. Further, the additional information generation unit 105 also generates calculation area information indicating that the MaxFALL value is calculated from the face frame area 202 illustrated in FIG. 2B as additional information. The additional information is sent to the display processing unit 108, and further sent to the IF processing unit 106 via the display processing unit 108.

The display processing unit 108 converts information that can be used in a general video transmission standard such as HDMI into information for the internal display device 109 by the display processing unit 108, and transmits the information to the internal display device 109. As a result, the internal display device 109 performs video display in which display luminance is controlled.

Further, the IF processing unit 106 converts the display image data and the additional information into a signal format conforming to a video transmission standard such as HDMI, and transmits the signal format to the external display device 107. As a result, the external display device 107 extracts the MaxFALL information and the calculation area information from the received transmission data, and adjusts backlight, electric current, voltage, etc. based on the extracted information to perform video display controlled at optimum display luminance.

### Another Configuration Example of Third Embodiment

The imaging apparatus of the third embodiment may have a configuration of FIG. 5B in addition to the configuration of FIG. 5A. FIG. 5B is a diagram showing a configuration in which a luminance value calculation unit 104 and an additional information generation unit 105 are separated for each data transmission destination display device from the configuration. of FIG. 5A. Therefore, in the configuration of FIG. 5B, the luminance value calculation unit 104 and the additional information generation units 105 are provided for both an external display device 107 and for an internal display device 109. In FIG. 5B, components alike those in FIG. 5A are denoted by the same reference numerals, and redundant description thereof is omitted. Since the configuration of FIG. 5B is a separate configuration corresponding to the external display device 107 and the internal display device 109 that are data transmission destinations, a video can be displayed on each of the external display device 107 and the internal display device 109.

### Other Embodiments

Embodiment(s) of the present disclosure can also be realized by a computer of a system or apparatus that reads out and executes computer executable instructions e.g., one or more programs) recorded on a storage medium (which nay also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described. embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-063724, filed Mar. 28, 2019, which is hereby incorporated by reference herein in its entirety.

What is claimed is:

1. An image processing device comprising:
at least one non-transitory memory that stores a program of instructions; and
at least one processor coupled to the at least one non-transitory memory and configured to execute the program of instructions to cause the image processing device to implement:
an acquisition unit configured to acquire a luminance value from an image;
a designation unit configured to designate a partial area of the image;
a generation unit configured to generate image information displayed on a display device; and
a notification unit configured to notify the display device that displays the image information of information elating to the luminance value,
wherein the acquisition unit acquires the luminance value from the partial area, and
the notification unit notifies the display device of information relating to the luminance value acquired from the partial area.

2. The image processing device according to claim 1, wherein the notification unit adds the information relating to the luminance value acquired from the partial area to the image information generated by the generation unit.

3. The image processing device according to claim 1, wherein the designation unit crops the designated partial area from an image captured by an imaging element.

4. The image processing device according to claim 3, wherein the designation unit crops the partial area from the image captured by the imaging element according to an aspect of the display device.

5. The image processing device according to claim 3, wherein the designation unit crops a specific area in the image captured by the imaging element as the partial area.

6. The image processing device according to claim 3, wherein the generation unit generates the image information obtained by superimposing an image visibly representing the cropped area on the image captured by the imaging element.

7. The image processing device according to claim 6, wherein the generation unit generates the image information on which an image of a line visibly representing the cropped area is superimposed.

8. The image processing device according to claim 3, wherein the generation unit generates the image information from the cropped area.

9. The image processing device according to claim 1, wherein the acquisition unit also acquires a luminance value of maximum luminance from the image, and
the notification unit notifies the display device of notification information that visibly represents that the luminance value of the maximum luminance is outside the partial area.

10. An image processing method comprising:
acquiring a luminance value from an image;
designating a partial area of the image;
generating image information displayed on a display device; and
notifying the display device that displays the image information of information relating to the luminance value,
wherein the acquiring acquires the luminance value from the partial area, and
wherein the notifying notifies the display device of information relating to the luminance value acquired from the partial area.

11. A non-transitory computer readable storage medium storing a program for causing a computer to execute an image processing method, the image processing method comprising:
acquiring a luminance value from an image;
designating a partial area of the image;
generating image information displayed on a display device; and
notifying the display device that displays the image information of information relating to the luminance value,
wherein the acquiring acquires the luminance value from the partial area, and
wherein the notifying notifies the display device of information relating to the luminance value acquired from the partial area.
